(19) United States
(12) Patent Application Publication
(10) Pub. No.: US 2011/0123308 A1
(43) Pub. Date: May 26, 2011

(54) Apparatus for Order-Picking and / or Restacking a Plurality of Palletised Packs

(75) Inventors: Kai Wegener, Munchen (DE); Peter Kirschner, Sochtenau (DE); Florian Hertel, Rosenheim (DE); Dieter Schwarzer, Kolbermoor (DE)

(73) Assignee: KRONES AG, Neutraubling (DE)

(21) Appl. No.: 13/014,784

(22) Filed: Jan. 27, 2011

Related U.S. Application Data
(63) Continuation of application No. PCT/EP2009/053306, filed on Mar. 20, 2009.

(30) Foreign Application Priority Data
Jul. 29, 2008 (DE) 10 2008 035 330.2

(51) Int. Cl. B65G 59/02

(52) U.S. Cl. 414/797.3; 414/801

(57) ABSTRACT

A device and a method are disclosed for loading and/or restacking a plurality of palleted containers. The device (2) comprises an apparatus (6) for partially raising the containers of an uppermost layer of palleted containers and for transferring said containers to a conveying table of a moving transport head (8). The apparatus (6) is made up of a driven conveyor roller (10) that is integrated into the transport head (8). In a preferred embodiment, the transport head (8) is designed as a shutter head (9). The method shows that the conveyor roller (10) of the transport head (8) holds at least one row of a layer of containers in the transport head. The transport head (8) is provided with an apparatus (6) that at least partially raises one row of containers of at least one uppermost layer of palleted containers.

### CROSS REFERENCE TO RELATED APPLICATIONS

This application is filed under 35 U.S.C. §120 and §365(c) as a continuation of International Patent Application PCT/EP2009/053306, filed Mar. 20, 2009, which application claims priority from German Patent Application No. DE 10 2008 035 330.2, filed on Jul. 29, 2008, which applications are incorporated herein by reference in their entireties.

### FIELD OF THE INVENTION

The present invention relates to an apparatus for order-picking and/or restacking a plurality of palletised packs with a device for partially raising the packs of an uppermost layer of the palletised packs and for transferring them onto a transport plate of a movable transport head.

### BACKGROUND OF THE INVENTION

From WO 2006/088354 A1 an apparatus for depalletising objects onto a pallet is known, wherein a roll-on gripper head exhibits a plate at its leading edge. This plate exhibits a conveyor belt for the transport of the layers. For rolling-on the layers the gripper head is moved against the layers to be depalletised by a trolley in such a way that the layers are rolled-on row by row. In order to facilitate the loading of the layer the individual objects or layers, respectively, are supported by a counter support in order to facilitate the loading of the packs. The unloading of the layer is done in reversed order.

DE 10 2006 022 155 A1 discloses an improvement of the depalletising of stacked packs. A method for depalletising of stacked packs is proposed, in which the packs are raised in a friction locked way and are underrun by at least one carrier tray. The raising of the packs is done at two opposite sides. This application furthermore discloses an apparatus for depalletising stacked packs. This apparatus comprises a carrier tray and at least one roller for raising the packs, wherein the apparatus comprises at least two rollers, one opposite the other. A disadvantage of this apparatus is that the carrier plates extend sideways beyond the head during loading and unloading. This is not the case with the apparatus according to the invention.

From EP 1 908 709 A1 an apparatus for loading packs with a carrier tray for the packs is known. The apparatus exhibits an at least partially open front side for inserting the packs and is characterised by a movably connected pusher for displacing the packs along a horizontal loading direction through the open front side.

The German patent application 10 2008 002 831 A1 relates to an apparatus and a method for transferring grouped layers of packs into the loading station of a transport apparatus by means of a continuously drivable continuous conveyor. The loading station is a shutter head and comprises a pivotable bracket for securing the layers of packs at the side facing the continuous conveyor. Furthermore the pivotable bracket imparts an additional component of motion along the direction of transport to the layers of packs already in the loading station, in order to push the layers of packs already at least partially in the loading station farther or completely, respectively, into the shutter head.

### SUMMARY OF THE INVENTION

It is the object of the invention to create an apparatus requiring little space for palletising and increasing the speed at palletising.

The above object is achieved by an apparatus for order-picking and/or restacking plural palletized packs comprising:
a device for raising the packs of at least one partial layer of at least one layer of the palletized packs;
a movable transport head with a transport plate for receiving the palletized packs; and
at least one driven roll-on roller integrated at the transport head of the device.

It is the object of the invention to create a method for palletizing and increasing the speed at palletizing.

The above object is achieved by a method for order-picking and/or restacking of plural palletized packs, comprising the following steps:
driving a roll-on roller of a the transport head;
partially raising the at least one row of packs of at least one layer of the palletized packs with the roll-on roller;
loading at least one row of at least one layer of packs into the transport head.

The apparatus according to the invention for depalletising.plural palletised packs exhibits a device for partially raising the packs of at least one uppermost layer. Furthermore, the apparatus serves for transferring the packs onto a transport plate of a movable transport head. The apparatus has a driven roll-on roller integrated into the transport head. Integrated in the context of the driven roll-on roller means, that the device with the roll-on roller and drive is an integral component of the transport head or of the shutter head, respectively, of the apparatus. The known transport head in this apparatus is configured as a shutter head. Using such a device with an integrated and driven roll-on roller in the shutter head has some advantages. One advantage for example is that the apparatus requires less space for palletising the stacked packs. A further advantage is that at the same time the speed at palletising the stacked packs is increased. This apparatus also is suitable for seizing and releasing objects packaged in various manners.

An embodiment of the apparatus according to the invention exhibits a shutter head suitable for the seizing and releasing of at least partial layers. With the apparatus it is for example possible to seize single outward packs of an uppermost layer of a pallet. At releasing at least partial layers the shutter head is opened and the partial layers to be depalletised can, for example, be placed again on a pallet. An advantage of the apparatus is that due to the comfortable seizing and releasing of the packs, layers of packs or similar objects the overall speed between seizing and releasing can be increased.

In a further preferred embodiment of the apparatus according to the invention the roll-on roller is provided with a coating. The coating of the roll-on roller preferentially exhibits an adequate friction coefficient between the bottom surfaces and the side surfaces of the packs or layers of packs to be seized and the roll-on roller. Due to the friction coefficient between the coated roll-on roller and the side surface and bottom surface of the packs the transfer of the packs into the shutter head is facilitated. It is particularly advantageous to provide the coating of the roll-on roller as a rubber coating. The coating could advantageously also be made of silicone material. This increases the grip for the transfer of individual packs or layers of packs into the shutter head of the apparatus.

In a further embodiment of the apparatus according to the invention the roll-on roller is provided with a patterning on its surface. This for example could be moulded lozenge-like with notches as recesses. This has the advantage that on the one hand possibly deposited dirt or similar substances do not decrease the friction coefficient between the roll-on roller and the packs, on the contrary the notches serve as dirt buffers. On the other hand the moulded lozenges as a surface also can increase the friction coefficient between the roll-on roller and the pack in such a way that a kind of form-locking connection with the packs is created due to the chosen profile.

In order to moreover facilitate the transfer of the packs into the shutter head it is advantageous to provide the surface of the roll-on roller with a patterning which is a lozenge-like pattern with notches as recesses.

In a further embodiment of the apparatus according to the invention the roll-on roller integrated into the transport head of the device is controlled by a drive. Here preferentially an electromotor could be used. The electromotor can be fashioned as a direct drive or as a drive with gears. A combination of further types of drives known to the person skilled in the art can not be excluded here.

In an embodiment a roll-on roller is provided on each of two sides of the transport head. Preferentially the transport head again is a shutter head. Providing a roll-on roller on two sides of the shutter head increases the flexibility of the apparatus. This is obvious from the fact that the packs or layers of packs to be seized can be fed to the shutter head from two sides. In this way for example the apparatus could seize packs alternatingly from two different pallets, which is also possible with one roll-on roller only. A further advantage is that the speed at seizing and releasing the individual packs or layers of packs is considerably increased.

The apparatus according to the invention with the driven roll-on roller integrated into the shutter head is used in particular for depalletising packs or layers of packs. The packs predominantly comprise liquid containers. The packs or layers of packs can be fashioned in various ways, like for example soft packs, articles packaged in cardboard, coffee packages, shrink pads, shrink trays, wrap-around cardboard, bricks, sugar packages and in a preferred application the containers are used for liquids.

A method according to the invention for order-picking and/or restacking plural palletised packs comprises the following steps: The roll-on roller of the transport head loads at least one row of at least one layer of packs into the transport head. The transport head therein is provided with a device partially raising at least one row of packs from at least one uppermost layer of the palletised packs. Herein a plurality of process flows can be conceived of Given a suitable configuration of the shutter head and a corresponding height of the packs, it is conceivable to roll-on at least two layers at once and to load them into the shutter head at once.

The method furthermore discloses that at least one row of at least one layer is taken from each of at least two pallets with different types of packs by the transport head. This row is then placed onto a new pallet to be composed.

The method according to the invention furthermore shows that the layers of rows of at least two different types of packs placed onto the new pallet to be composed can be seized again and placed down in a reordered fashion.

### BRIEF DESCRIPTION OF THE DRAWINGS

Below embodiments illustrate the invention and its advantages with reference to the accompanying figures. The size ratios between the individual elements in the figures do not always correspond to the real size ratios, as some shapes are shown simplified and other shapes for the sake of clarity are shown enlarged with respect to other elements.

FIG. 1 shows a perspective global view of an apparatus for transferring layers of packs into a shutter head. The apparatus is the subject of German patent application 10 2008 002 831 A1.

FIG. 2 shows a perspective view of the apparatus.

FIGS. 3 to 9 in schematic sectional views show various transfer and roll-on positions of the apparatus.

FIG. 10 shows a cross-section of a roll-on roller.

FIGS. 11 to 14 in schematic top views show the arrangement of the layers of packs before and after, respectively, the order-picking and/or restacking of plural palletised packs.

### DETAILED DESCRIPTION OF THE INVENTION

Identical reference numerals are used for like elements of the invention or elements of like function. Furthermore for the sake of clarity only those reference numerals are shown in the individual figures that are necessary for the description of the respective figures. The embodiments shown only are examples of the apparatus according to the invention or of the method according to the invention and do not constitute a final limitation.

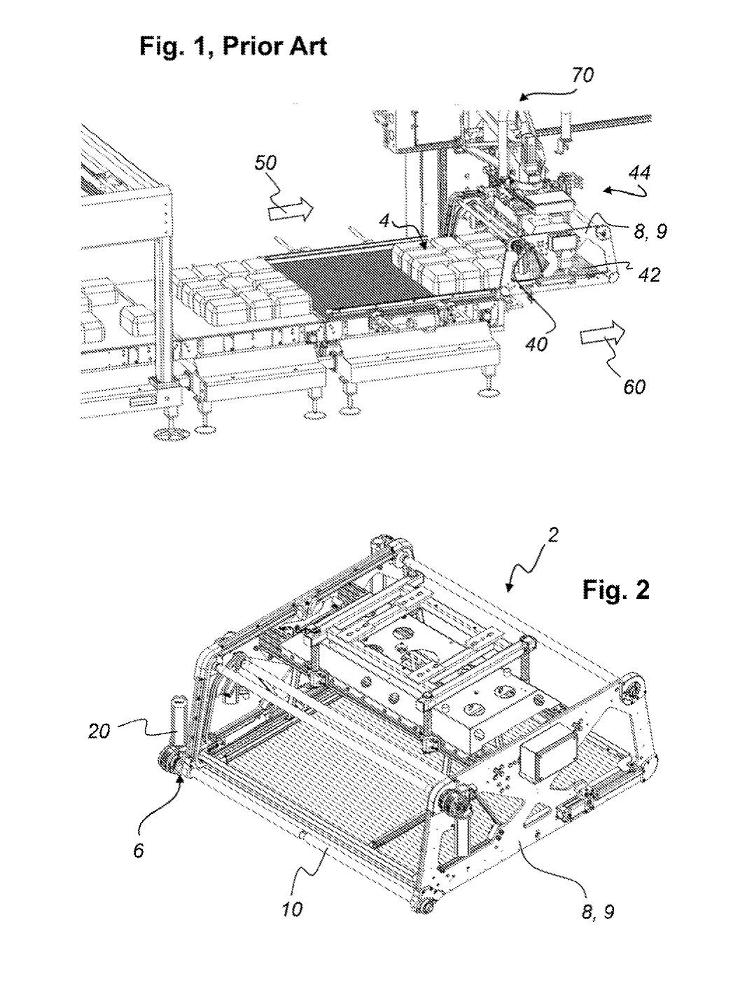

FIG. 1 shows a perspective view of a conventional apparatus for transferring grouped layers of packs 4 into the loading station 44 of a transport apparatus 70 by means of a continuously drivable continuous conveyor. The loading station 44, which here is a shutter head 9, comprises a pivotable bracket 40 provided for securing the layers of packs 4 at the side facing the continuous conveyor. Furthermore the pivotable bracket 40 imparts an additional component of motion 60 along the direction of motion 50 to the layers of packs 4 already at least partially introduced into the loading station 44, in order to push the layers of packs 4 already at least partially in the loading station 44 farther or completely, respectively, into the shutter head 9. In the loading station 44 a plurality of rollers 43 is provided, which facilitate the transfer of the layer of packs 4 into the loading station 44 of the transport apparatus 70. The rollers 42 form the support for the respective layer of packs 4. By the combined transport from the continuous conveyor into the loading station 44 by the actively driven rollers 42 a considerable saving of time or a reduction of the cycle time is achieved.

Though in the subsequent figures only two packs per layer are drawn, this is not to be taken as a limitation of the invention. The drawings are only schematic representations of the inventions and for the sake of clarity are restricted to the elements relevant to the invention. It is obvious to a person skilled in the art that the shutter head preferentially always seizes at least one entire row of a layer of packs. Furthermore the shutter head could also roll-on and restack more than one layer of packs. Releasing the seized layer or partial layer is done by opening the transport plate of the shutter head in the centre. This is very economical in terms of space, as no carrier plates or auxiliary means protrude sideways from the head. The transport plate may consist of roller or link elements.

FIG. 2 is a perspective view of an apparatus 2 according to the invention with a roll-on roller 10 integrated at the transport head 8, for order-picking and/or restacking of packs. In the embodiments the transport head 8 is a shutter head 9. The apparatus 2 exhibits a device 6 with a driven roll-on roller 10 integrated at the front side of the transport head 8. The roll-on roller 10 is driven by a motor in a controlled fashion.

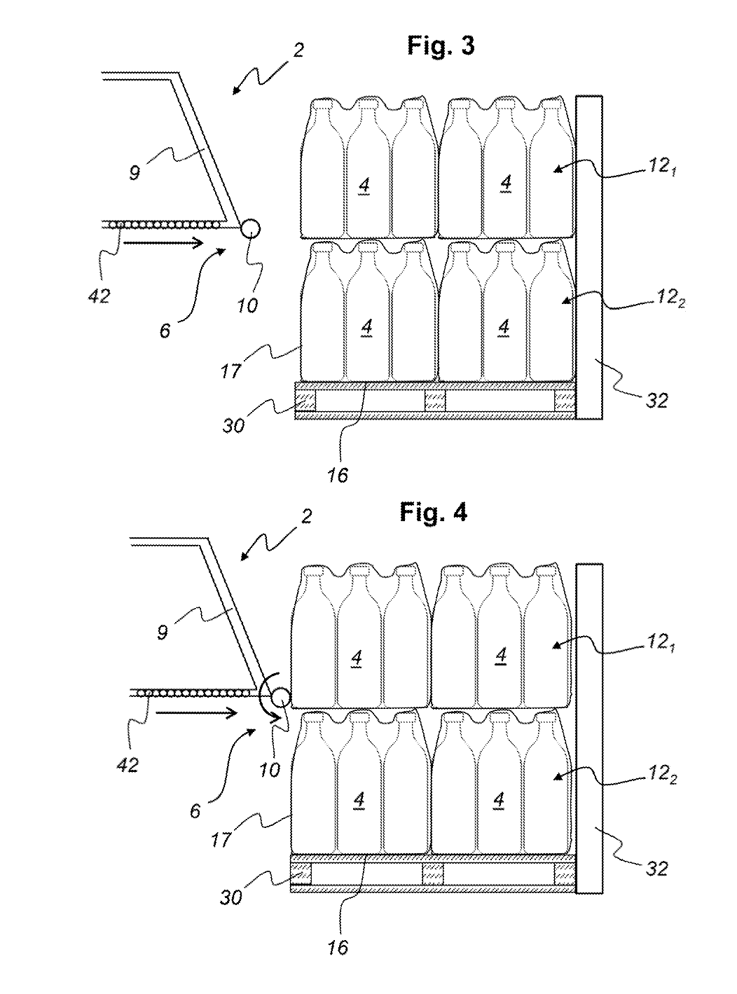

The FIGS. 3 and 4 in a sectional view show the apparatus 2 with the device 6 exhibiting the roll-on roller 10 while the shutter head 9 is brought up to the pack 4 or to the layer 12₁ of packs, respectively, The layers 12₁ and 12₂ of packs therein are arranged on a pallet 30 and are supported by a counter support 32 preferentially arranged at the back side of the pallet 30. This counter support 32 serves for facilitating the loading of the packs 4 or of the layers 12₁ and 12₂ of packs, respectively. The shutter head 9 directly approaches the side surface 16 of the first pack 4 of the uppermost layer 12₁ of packs. In FIG. 4 the roll-on roller 10 already is in immediate contact with the side surface 16 of the pack 4 of the uppermost layer 12₁ of packs and thus is on the verge of rolling on the first pack 4.

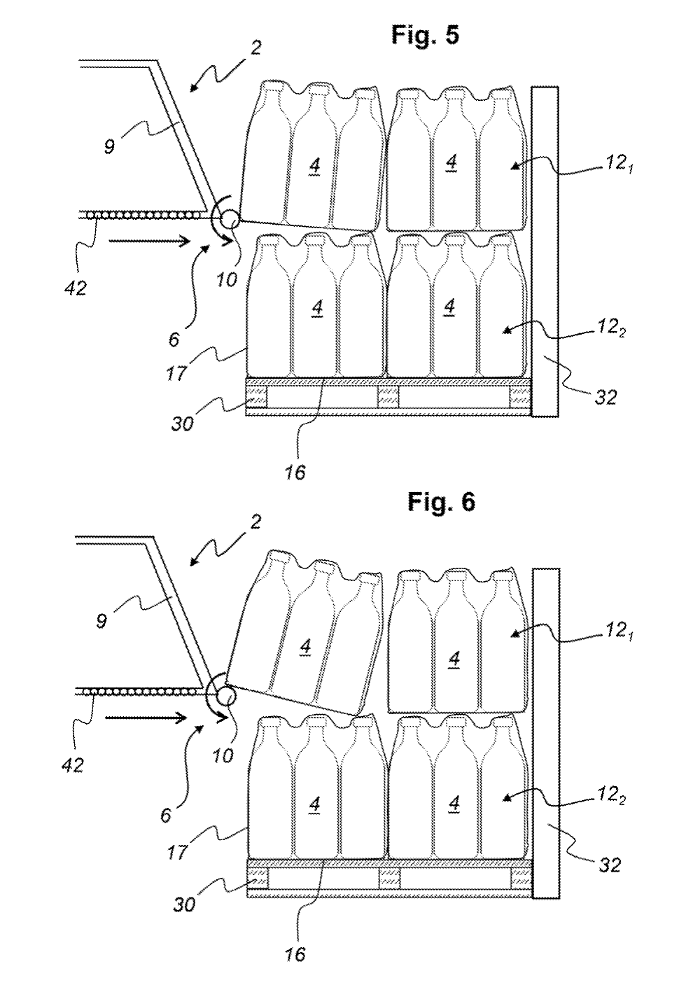

FIG. 5 in a sectional view shows the apparatus 2 with the first pack 4 of the uppermost layer 12₁ of packs already slightly tilted due to the beginning of the rolling-on by means of the roll-on roller 10. The roll-on roller herein is in contact with the lower part of the side surface 16 of the first pack 4 of the uppermost layer of packs 12₁ and continues the rolling-on already indicated in FIG. 4. The rolling-on of the first pack 4 is facilitated by the second pack 4 of the uppermost layer 12₁ of packs acting as a support. The layers 12₁ and 12₂ of packs, as in the following embodiments, are again arranged on a pallet 30 and supported by a counter support 32.

FIG. 6 also shows a sectional view of the apparatus 2, with the first pack 4 of the uppermost layer 12₁ of packs already tilted more by the advance of the rolling-on process than at an earlier instant shown in FIG. 5. The first pack 4 of the uppermost layer 12₁ of packs herein already breaks contact with the second pack of the first layer 12₁ of packs. The bottom surface 16 of the first pack 4 of the uppermost layer 12₁ of packs is in contact with the top side of the roll-on roller 10.

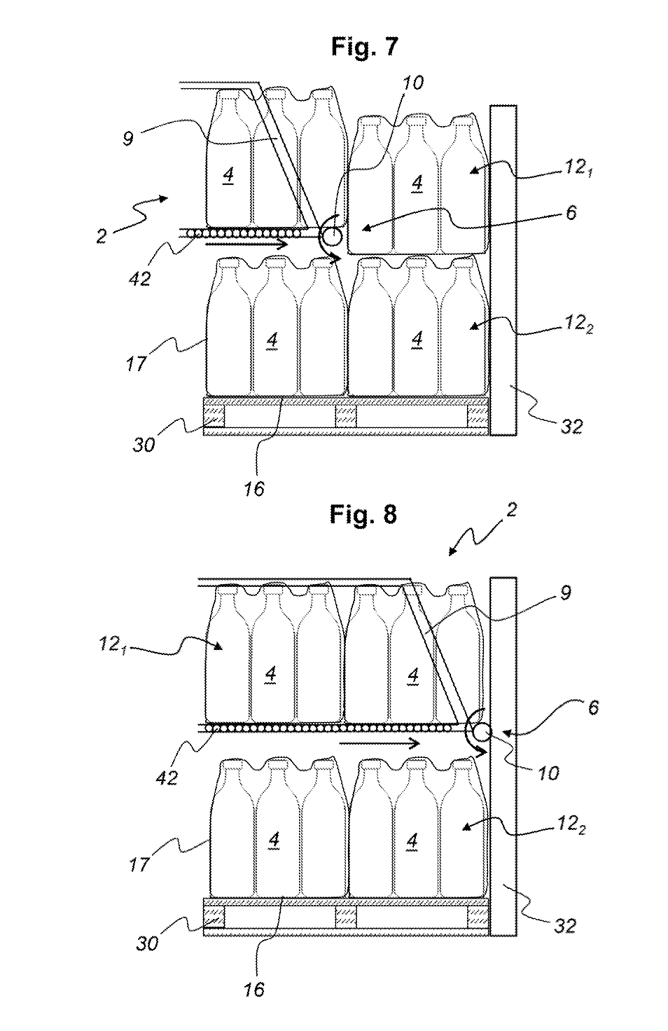

FIG. 7 in a further sectional view shows the apparatus 2 with the first pack 4 of the uppermost layer 12₁ of packs almost entirely rolled on and loaded into the transport head 8 by the rotary motion of the roll-on roller 10 and the horizontal movement of the transport head 8 occurring alongside. The first pack 4 of the uppermost layer 12₁ of packs therein is in a horizontal position and exhibits a small distance to the first pack 4 of the bottom layer 12₂ of packs. Within the shutter head 9 a plurality of rollers 42 are provided, which facilitate the transfer of the packs 4 or of the layers 12₁ and 12₂ of packs during further transport. The rollers 42 form a support for the respective packs 4 or layers 12₁ and 12₂ of packs. The rollers 42 for example can be provided with one or plural electromotors, so that the rollers can be individually driven in order to guarantee a better transport of the packs 4 or of the layers 12₁ and 12₂ of packs within the shutter head 9.

FIG. 8 in a sectional view shows the further progress of the motion sequence of the apparatus 2 with the bottom surface 16 of the first pack 4 of the uppermost layer 12₁ of packs already in contact with the rollers 42 inside the shutter head 9. The second pack 4 of the uppermost layer 12₁ of packs also is in a horizontal position and is in contact with the upper side of the roll-on roller 10 and has been rolled-on almost completely by the roll-on roller 10. The second pack 4 of the uppermost layer 12₁ of packs herein has mostly been loaded into the shutter head 9 of the apparatus 2 and already exhibits a small distance to the counter support 32. Due to the loading of the uppermost layer 12₁ of packs this also exhibits a small distance to the bottom layer 12₂ of packs.

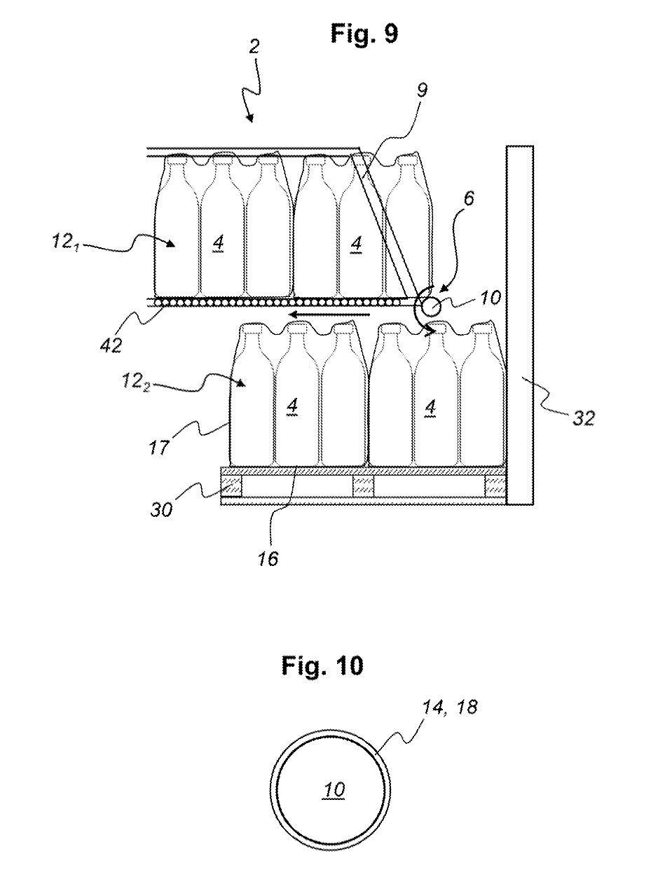

FIG. 9 again in a sectional view shows a further displacement position of the shutter head 9 of the apparatus 2 after loading of the two packs 4 of the uppermost layer 12₁ of packs. Herein the two packs 4 of the uppermost layer 12₁ of packs already are located on the rollers 42 within the shutter head 9, as described in FIG. 8. The two packs 4 of the uppermost layer 12₁ of packs in this position exhibit a smaller distance to the bottom layer 12₂ of packs and a larger distance to the counter support 32 behind the pallet 30. After loading the two packs 4 of the uppermost layer of packs this can for example be palletised onto a different pallet provided.

FIG. 10 shows an embodiment of the roll-on roller 10 in detail. The roll-on roller 10 herein exhibits a coating 14 and for example may be provided with a rubber coating 18, in order to facilitate the transfer of the packs 4 or of the layers 12₁ and 12₂ of packs, respectively, into the shutter head 9 of the apparatus 2.

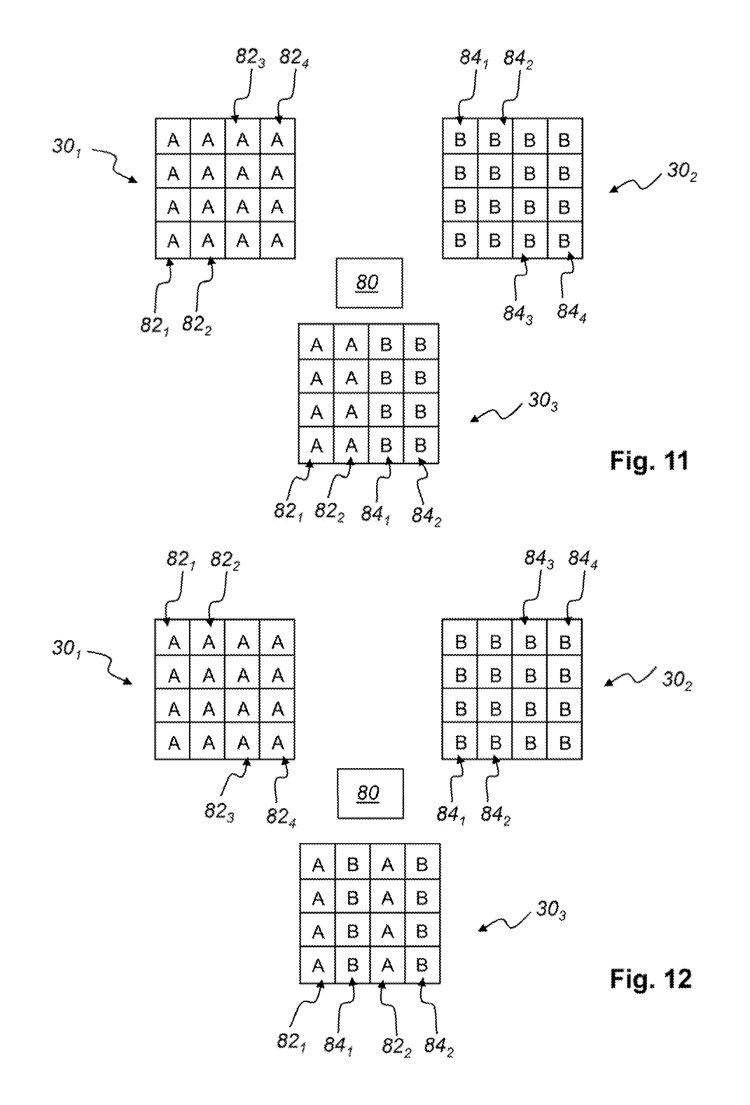

FIG. 11 in top view shows the arrangement of rows of an uppermost layer of packs before and after the restacking of the layers of packs. The individual rows of a layer of packs 82₁, 82₂, 82₃, 82₄ on a first pallet 30₁ and the individual rows of packs 84₁, 84₂, 84₃, 84₄ on a second pallet 30₂ are placed onto a third pallet 30₃ in a mixed order. To this end the shutter head of a robot 80 may, in parallel or serially, seize two rows of a layer 82₁ and 82₂ from the first pallet 30₁, and subsequently seize two rows of a layer 84₁ and 84₂ from the second pallet 30₂. This layer of mixed types of packs is then placed onto the third pallet 30₂.

FIG. 12 in a top view shows a further possibility of the arrangement of rows of an uppermost layer of packs. Herein the robot 80 seizes a row of individual layers of packs 82₁, 84₁, 82₂, 84₄ altematingly from the first pallet 30₁ and from the second pallet 30₂. The layer of mixed types of packs in the shutter head of the robot 80 is then placed onto the third pallet 30₃.

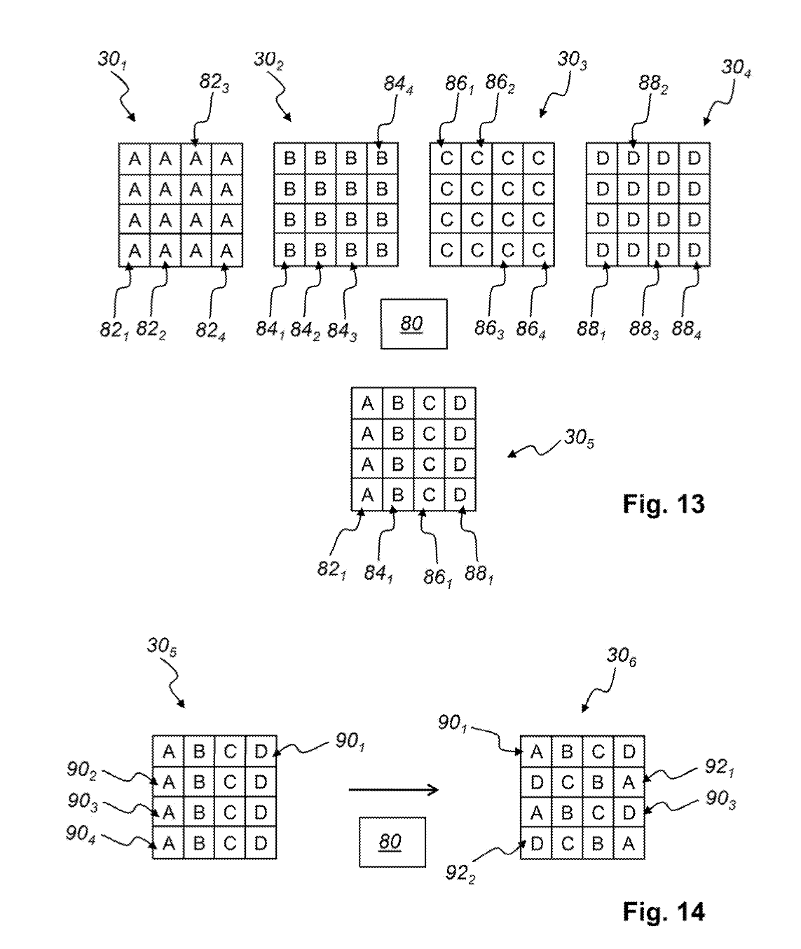

FIG. 13 in a top view shows a further possibility of the arrangement of rows of a layer of packs. In this arrangement the shutter head of the robot 80 seizes a row of individual layers of packs 82₁, 84₁, 86₁, 88₁ altematingly from the first pallet 30₁, the second pallet 30₂, the third pallet 30₃ and the fourth pallet 30₄. This layer is then placed onto a fifth pallet 30₅.

FIG. 14 in a top view shows a continuation of the restocking of the rows of packs of at least one layer of FIG. 13. Therein the rows of an uppermost layer of packs are restacked from the fifth pallet 30₅ onto a sixth pallet 30₆ in such a way that the row of a layer comprises different packs. Herein the robot 80 first seizes a row 90₁ of different packs of the pallet 30₅. Afterwards the shutter head is turned 180° and rolls on the next row 90₂ of packs from the fifth pallet 30₅. This process is repeated, until the layer in the shutter head is complete. Subsequently the complete layer is placed on the pallet 30₆. Thus a completely reoriented layer of different types of packs is formed.

Although the above description describes palletising in layers, this is not to be taken as a limitation of the invention. Pallettising in rows is also possible with the shutter head or transport head, respectively, Of the robot 80.

The invention has been described with reference to a preferred embodiment. It is obvious to a person skilled in the art, however, that. modifications and alterations can be made, without leaving the scope of the subsequent claims.

What is claimed is:

1. Apparatus for order-picking and/or restacking plural palletized packs comprising:
a device for raising the packs of at least one partial layer of at least one layer of the palletized packs;
a movable transport head with a transport plate for receiving the palletized packs; and
at least one driven roll-on roller integrated at the transport head of the device.

2. The apparatus of claim 1, wherein the transport head is a shutter head.

3. The apparatus of claim 2, wherein the shutter head is designed for seizing and releasing of at least partial layers.

4. The apparatus of claim 1, wherein a surface Of the roll-on roller is provided with a coating.

5. The apparatus of claim 4, wherein the surface of the roll-on roller is textured.

6. The apparatus of claim 4, wherein a friction coefficient between the surface of the roll-on roller and the packs to be rolled-on is such that the packs are transferred into the shutter head.

7. The apparatus of claim 4, wherein the coating exhibits a rubber coating.

8. The apparatus of claim 1, wherein a drive is associated with the roll-on roller, which drives the roll-on roller by a motor and in a controlled manner.

9. The apparatus of claim 1, wherein one roll-on roller is provided on each of the two sides of the transport head.

10. Method for order-picking and/or restacking of plural palletized packs, comprising the following steps:
driving a roll-on roller of a the transport head;
partially raising the at least one row of packs of at least one layer of the palletized packs with the roll-on roller;
loading at least one row of at least one layer of packs into the transport head.

11. The method of claim 10, wherein, in parallel or serially, at least one row of at least one layer is taken from each of at least two pallets with different types of packs with the transport head, and wherein this at least one row is placed onto a new pallet to be composed.

12. The method of claim 11, wherein layers of rows of at least two different types of packs placed onto the new pallet to be composed are seized again and placed down in a reordered arrangement.
